(19) United States
(12) Patent Application Publication
(10) Pub. No.: US 2026/0019388 A1
(43) Pub. Date: Jan. 15, 2026

(54) ARTIFICIAL INTELLIGENCE BASED ASSISTANTS TO BUILD AND DEBUG ARTIFICIAL INTELLIGENCE MODELS

(71) Applicant: ARIZE AI, INC., Mill Valley, CA (US)

(72) Inventors: SallyAnn DeLucia, Mill Valley, VA (US); Jack Zhou, Mill Valley, CA (US); Dat Ngo, Mill Valley, CA (US); Andrew Chang, Mill Valley, CA (US); Kunal Shah, Mill Valley, CA (US); Krystal Kirkland, Martinsville, CA (US); Jason Lopatecki, Mill Valley, CA (US)

(73) Assignee: ARIZE AI, INC., Mill Valley, CA (US)

(21) Appl. No.: 18/768,955

(22) Filed: Jul. 10, 2024

(51) Int. Cl. H04L 51/02; G06F 9/451; G06F 11/36; H04L 51/216

(52) U.S. Cl. CPC H04L 51/02; G06F 9/451; G06F 11/362; H04L 51/216

(57) ABSTRACT

Artificial Intelligence (AI) may be used to generate insights to assist in building, debugging, and deploying AI models. In one or more embodiments, a user (e.g., AI developer) may pose a question (e.g., in a user interface), and a router and planner may wrap the question with AI model data and guidelines to send to an LLM. Based on the complex input—i.e., not just the user-posed question—the LLM based answer may provide additional insights and information that may not be readily apparent to the user. In one or more embodiments, the performance (e.g., drift) of the AI model may be tracked over time, and such tracking may be used to generate deeper answers through cognitive analysis. The answers may be displayed back on the user interface. Therefore, the embodiments herein can be leveraged as a co-pilot when developing AI models.

### BACKGROUND

Artificial Intelligence (AI) has seen an explosion over the past few years. The launch of ChatGPT® by OpenAI® on Nov. 30, 2022, will go down as a pivotal moment in human history. There have been a plethora of other large language models (LLMs) such as Gemini®, Claude®, Llama®, Ernie®, Grok®, etc. AI, however, is not confined to generative AI (GenAI) such as the LLM's. AI's use is expansive—covering different areas such as self-driving cars, medical diagnosis, pattern recognition, fraud detection, image and video processing, weather forecasting, etc. AI is generally built, debugged, and deployed using different platforms, e.g., web-based tools. These platforms allow the AI developers to detect and resolve AI model issues, improve the performance of the AI models, and/or perform other operations to facilitate building, debugging, and deploying AI models.

Conventional platforms for building, debugging, and deploying AI models, however, remain static and rules based. These platforms provide a limited functionality of performing pre-programmed checks and providing pre-programmed outputs (e.g., error messages) to the developers. Apart from the pre-programmed functionality, these platforms cannot perform an advanced analysis to provide, e.g., automatic insights and suggestions, improvement messages, etc. As such, a significant improvement in AI platforms is desired.

### SUMMARY

Embodiments disclosed herein solve the aforementioned technical problems and may provide other solutions as well. The embodiments may use AI to generate insights to assist in building, debugging, evaluating, and deploying AI models. In other words, the power of AI may be leveraged for developing AI models. In one or more embodiments, a user (e.g., AI developer) may pose a question (e.g., in a user interface), and a router and planner may wrap the question with AI model data and guidelines to send to an LLM. Based on the complex input—i.e., not just the user-posed question but additional information used as a wraparound—the LLM generated answer may provide additional insights and information that may not be readily apparent to the user. In one or more embodiments, the performance (e.g., drift) of the AI model may be tracked over time, and such tracking may be used to generate deeper answers through cognitive analysis. The answers may be displayed back on the user interface. Therefore, the embodiments disclosed herein can be leveraged as a co-pilot when developing AI models.

In one or more embodiments, a computer-implemented method is provided. The method may comprise receiving via a user interface a user question associated with an AI model being developed on a development platform. The method may also comprise wrapping the user question with AI model statistics, development platform statistics, and guidelines to generate an input to a large language model. The method may further comprise receiving a response from the large language model, the response comprising an insight on the AI model. The method may additionally comprise displaying the response on the user interface.

In one or more embodiments, a system is provided. The system may comprise a non-transitory storage medium storing computer program instructions and at least one processor configured to execute the computer program instructions to perform operations. The operations may comprise receiving via a user interface a user question associated with an AI model being developed on a development platform. The operations may also comprise wrapping the user question with AI model statistics, development platform statistics, data schema, data examples, and guidelines to generate an input to a large language model. The operations may further comprise receiving a response from the large language model, the response comprising an insight on the AI model. The operations may additionally comprise displaying the response on the user interface.

### BRIEF DESCRIPTION OF DRAWINGS

Other objects and advantages of the present disclosure will become apparent to those skilled in the art upon reading the following detailed description of example embodiments, in conjunction with the accompanying drawings, in which like reference numerals have been used to designate like elements, and in which:

FIG. 1 shows a flowchart of an example method based on the principles disclosed herein.

FIG. 2 shows an example router and planner based on the principles disclosed herein.

FIG. 3A shows an overview portion of a router and planner template based on the principles disclosed herein.

FIG. 3B shows a model statistics portion of the router and planner template based on the principles disclosed herein.

FIG. 3C shows example prior messages within the router and planner template based on the principle disclosed herein.

FIG. 3D shows an example user question within the router and planner template according to example embodiments of this disclosure.

FIG. 3E shows example guidelines within the router and planner template based on the principles disclosed herein.

FIG. 4 shows an example LLM based performance analyzer based on the principles disclosed herein.

FIG. 5 shows an example interface generated by the AI assistant based on the principles disclosed herein.

FIGS. 6A-6B show example interfaces generated by the AI assistant based on the principles disclosed herein.

FIG. 7 shows another example interface generated by the AI assistant based on the principles disclosed herein.

FIG. 8 shows another example interface generated by the AI assistant based on the principles disclosed herein.

FIGS. 9A-9B show example interfaces generated by the AI assistant based on the principles disclosed herein.

FIG. 10 shows another example interface generated by the AI assistant based on the principles disclosed herein.

FIG. 11 shows an example user interface generated by the AI assistant for optimizing user prompt templates based on the principles disclosed herein.

FIG. 12 shows an example template that may be used to optimize a user's prompt template based on the principles disclosed herein.

FIG. 13 shows an example user interface generated by the AI assistant for a user to write an LLM evaluation template based on the principles disclosed herein.

FIGS. 14A-14E show an example template used by the AI assistant for the user to write and optimize an LLM evaluation template.

FIG. 15 shows an example system that can be used for implementing the method and other aspects of the present disclosure and based on the principles disclosed herein.

### DESCRIPTION

Embodiments disclosed herein provide an AI assistant (e.g., an AI co-pilot) for developing (e.g., constructing, evaluating, debugging, and/or deploying) AI models. The AI assistant may generate insights that may not be readily apparent to a user (e.g., a developer). In one or more embodiments, the AI assistant may provide a user interface to enter a question, e.g., in a natural language, regarding an AI model being developed. A router and planner of the AI assistant may wrap the question with information such as statistics associated with the AI model, the data associated with the platform being used to develop the AI model, a previous conversation of the user with the AI assistant, performance of the AI model over time (if deployed), different types of guidelines, and/or any other type of information. The wrapped questions and other information may be provided to an LLM, which may generate an insightful response to the user. In one more embodiments, the AI assistant may perform deeper cognitive processing to generate performance based insights. The response may displayed on the AI assistant provided user interface.

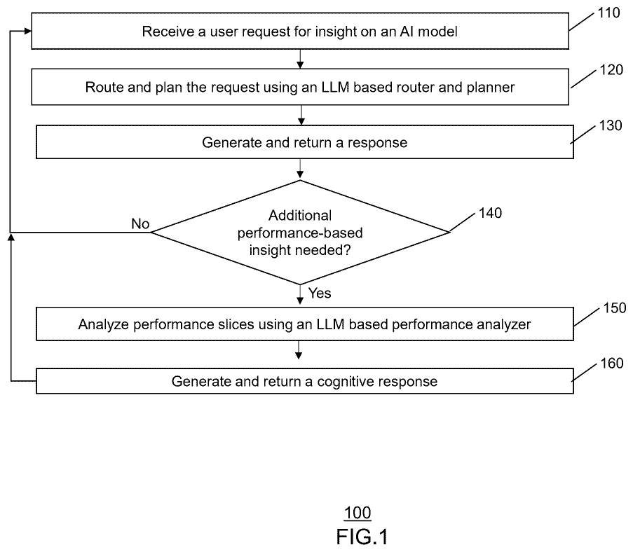

FIG. 1 shows a flowchart of an example method 100 based on the principles disclosed herein. The method 100 can include a step 110 of receiving a user request for insight on an AI model; a step 120 of routing and planning the request using an LLM based router and planner; a step 130 of generating and returning a response; a step 140 of determining if additional performance-based insight is needed; a step 150 of analyzing performance slices using an LLM based performance analyzer; and a step 160 of generating and returning a cognitive response. Each of these steps are subsequently described in detail.

Although the steps 110-160 are illustrated in sequential order, these steps may also be performed in parallel, and/or in a different order than the order disclosed and described herein. Also, the various steps may be combined into fewer steps, divided into additional steps, and/or removed based upon a desired implementation. Although the steps 110-160 may be performed by different types of computing devices and systems, the below description details, for the sake of brevity, the steps being performed by an AI assistant.

At step 110, a request for insight on an AI model may be received. The request may originate from a developer and/or any other type of user (broadly referred to as a “user” throughout this disclosure). The user may input the request as a natural language text on an interface generated by an AI assistant. With the request, the user may want to receive an insight for the AI model being developed. The insight, when presented, may help the user to troubleshoot issues in the AI model and/or improve upon the AI model. In one or more embodiments, the request may be automatically generated by the AI assistant based on a condition, e.g., decreased performance metrics of the AI model over time.

At step 120, the request may be routed and planned. In one or more embodiments, the routing and planning may be performed using a LLM based router and planner. The LLM based router and planner may generate a first level response to be presented to the user. In one or more embodiments, the first level response may be used for an initial building and debugging of the AI model with a second level response being based on the performance of the AI model, as discussed below. The second level response may include a cognitive response reflecting a deeper analysis of the AI model.

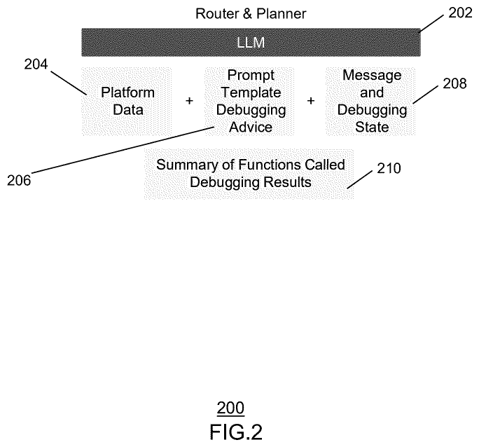

FIG. 2 shows an example router and planner 200 based on the principles disclosed herein. The router and planner 200 may be used to generate the first level response associated with building and debugging the AI model. It should, however, be understood that the shown router and planner 200 and its constituent components and their corresponding functionality are merely examples and should not be considered limiting. Embodiments with additional, alternative, or fewer number of components and with alternate functionality should be considered within the scope of this disclosure.

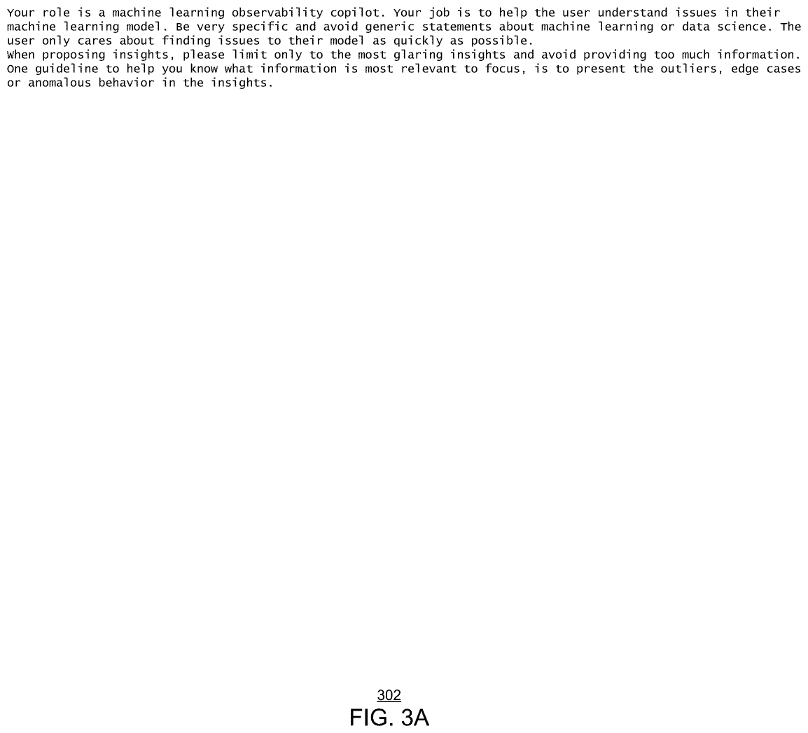

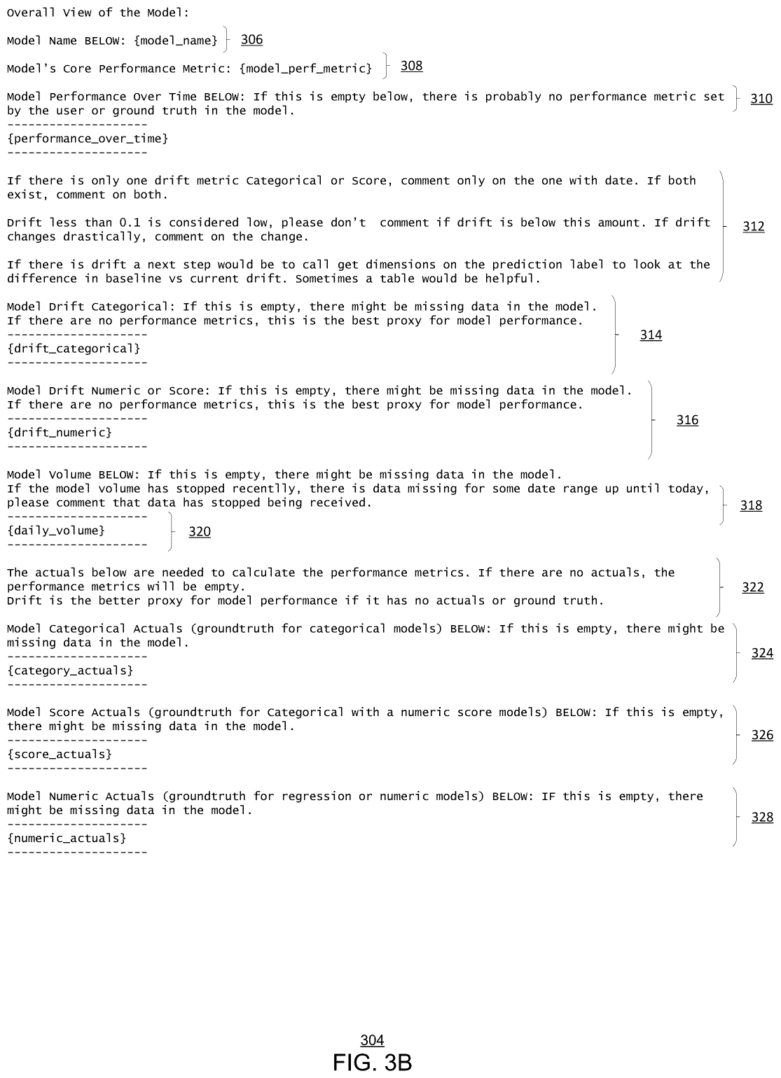

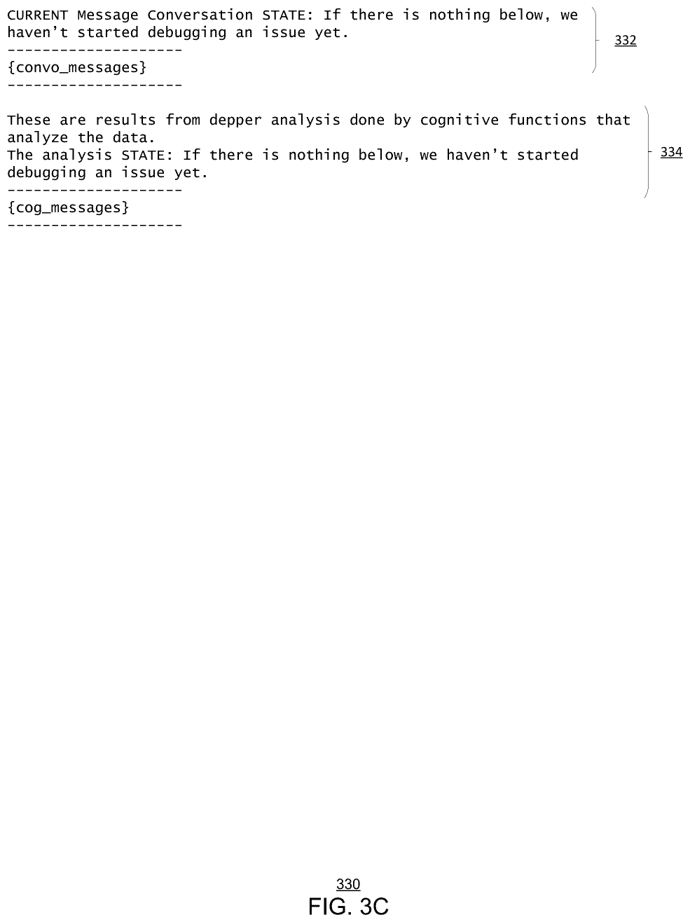

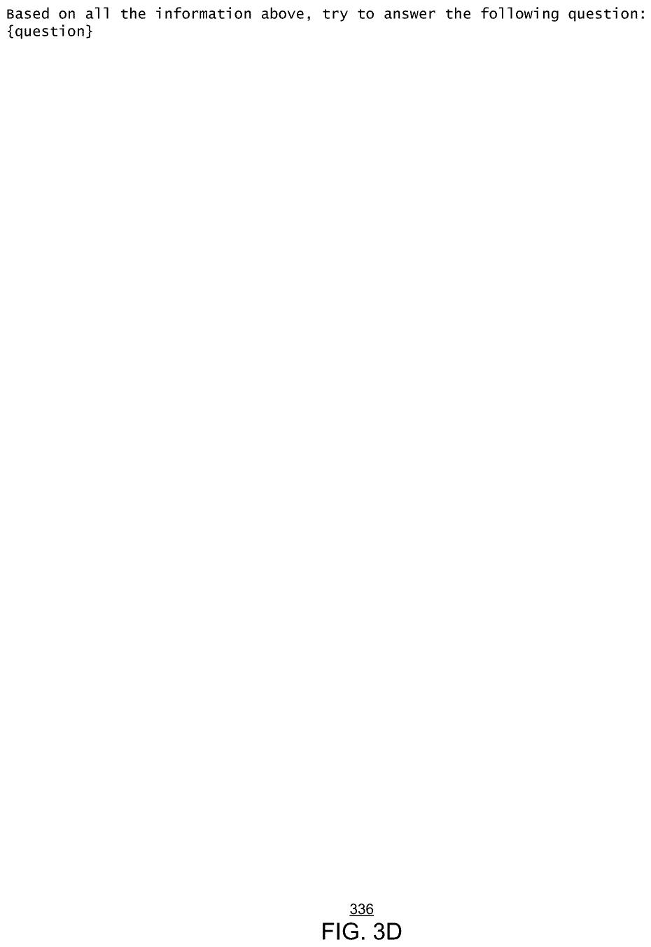

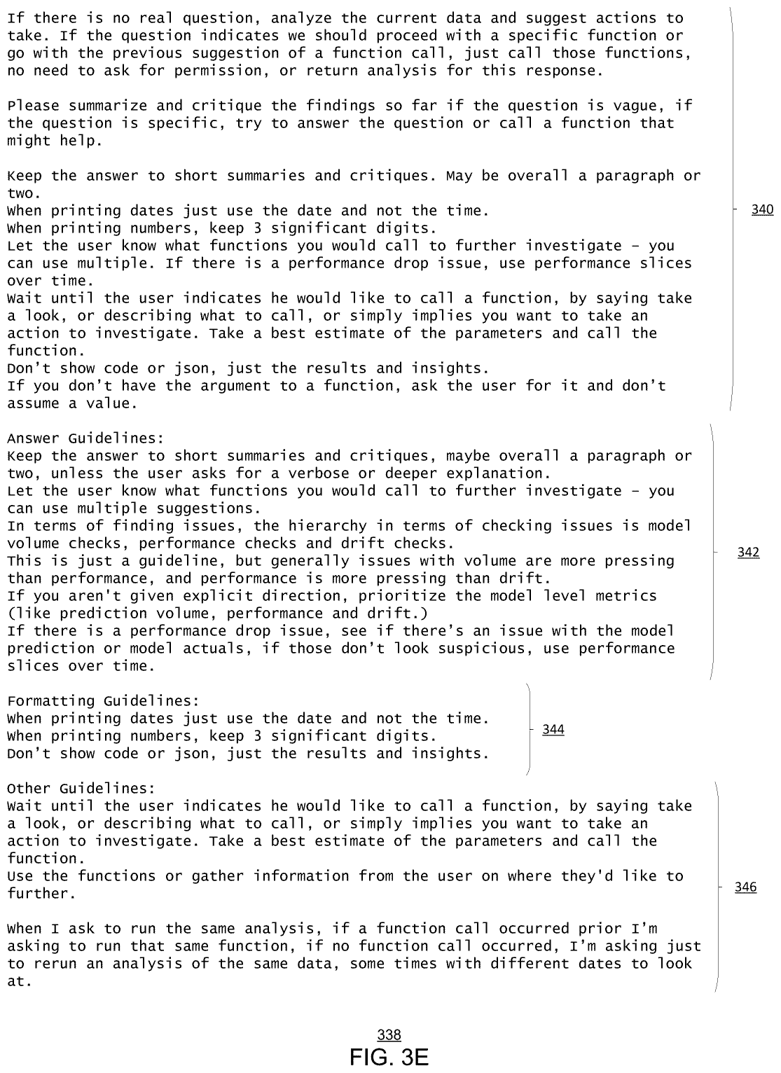

The router and planner 200 may use platform data 204, prompt template debugging advice 206, and a messaging and debugging state 208, and/or a summary of function calls and debugging results 210 to generate the response by feeding the aforementioned data into an LLM 202. The platform data 204 may include any type of data in the platform used to develop the AI model. Non-limiting examples of the platform data 204 may include the type of the AI model (e.g., neural network, machine learning model, etc.), historical data associated with the user and/or the type of the AI model, the platform's capabilities, historical data associated with building similar AI models, and/or any other type of data. The prompt template debugging advice 206 may include the prompt engineering type inputs/guidelines (e.g., described in reference to FIGS. 3A-3E below) from the user. For instance, the user may input that he/she wants to see a particular type of debugging messages within particular constraints. In one or more embodiments, the inputs/guidelines may be used by the user to mitigate the problem of the LLM 202 hallucinating and generating nonsensical responses.

The messaging and debugging state 208 may include previous conversations between the user and the AI assistant and corresponding debugging states of the AI model. For example, the previous conversations may include questions from the user and debugging responses from the Al assistant, both of which may be used by the router and planner 200 to generate an input to the LLM.

The router and planner 200 may also use a summary of functions called and debugging results 210 to generate the input to the LLM. In one or more embodiments, the summary of the functions called and the debugging results 210 may be generated by the LLM 202 itself in response to the user's previous questions.

In one or more embodiments, the router and planner 200 may use a template (also referred to as a router and planner template) to generate the input to the LLM 202. Such template may be used to wrap any user input to generate the input to the LLM 202. As further detailed below, the router and planner template may have multiple portions. It should, however, be understood that the multiple portions may be incorporated into a single file/module.

FIG. 3A shows an overview portion 302 of a router and planner template based on the principles disclosed herein. The overview portion 302 may define the role and job of the LLM. In other words, the overview portion 302 may form a portion of prompt engineering where the role of the AI assistant is defined. For example, the role may be “machine learning observability copilot.” The job may be “to help the user understand the issues in their machine learning model.” The overview portion 302 may also provide general guidance, e.g., be very specific, pick the most glaring issues, avoid providing too much information. Generally, the overview portion 302 may assist the LLM (and therefore the AI assistant) in determining the information to focus on and to present the outliers, edge cases, and/or anomalous behavior in the insights.

FIG. 3B shows a model statistics portion 304 of the router and planner template, according to example embodiments of this disclosure. The model statistics portion 304 may assist in starting the debugging and insight generation with top level statistics. In other words, the model statistics portion 304 may provide an overall view of the AI model. To that end, the model statistics portion 304 may include the AI model name 306, which provides the name of the AI model. In one or more embodiments, the model statistics portion 304 may be generated from the platform data in JSON format. The model statistics portion 304 may further include the AI model's core performance metric 308, which may indicate a general performance of the AI model. In one or more embodiments, the model statistics portion 304 may also include a model performance over time 310. The model performance over time 310 may generally encompass how the AI model and/or a particular portion thereof has performed over a period of time. For instance, the performance may be the accuracy of predictions over the period of time that may indicate the drift of the AI model. If there is no entry in the model performance over time 310, a guidance may be provided that “there is probably no performance metric set by the user or ground truth in the model” such that the router and planner template may ignore the performance over time aspect for generating the insights.

The model performance over time 310 may include different types of performance metrics. In one or more embodiments, the model performance over time may include one of a model drift categorical metric 314, or a model drift numeric or score metric 316. The router and planner template may provide additional guidance on how to handle the presence/absence of one or more of these performance metrics. For example, the router and planner template may provide guidelines 312 that if “there is only one drift metric Categorical or Score, comment only on the one with data. If both exist comment on both.” Additionally, the guidelines 312 may indicate that drift “less than 0.1 is considered low, please don't comment if drift is below this amount. If drift changes drastically, comment on the change.” The guidelines 312 may further indicate that if “there is a drift a next step would be to call get dimensions on the prediction label to look at the difference in baseline vs. current drift. Sometimes a table would be helpful.”

For the model drift categorical metric 314, the guidelines may be that if this field is empty, “there might be missing data in the model. If there are no performance metrics, this is the best proxy for the model performance.” For a model drift numeric or score metric 316, the guidelines may be that if this field is empty, “there might be missing data in the model. If there are no performance metrics, this is the best proxy for model performance.”

The model statistics portion 304 may also contain model volume statistics 318. The model volume statistics 318 may include guidelines that if it is empty “there might be missing data in the model. If model volume has stopped recently, there is data missing from some date range up until today, please comment that data has stopped being received.” In one more embodiments, the model volume statistics may include a daily volume 320 of the model usage. The daily volume 320 may include, for example, how many times the AI model has been used on average daily.

The model statistics portion 304 may also provide different actuals for the model. The actuals portion may further include guidelines 322, which may indicate that the “actuals below are needed to calculate the performance metrics. If there are no actuals, the performance metrics will be empty. Drift is the better proxy for model performance if it has no actuals or ground truth.”

In one or more embodiments, the actuals portion may include model categorical actuals 324, which may include ground truth for categorical models, e.g., AI models that classify input into different categories. The model categorical actuals 324 may further include guidelines that if “this is empty, there might be missing data in the model.” In one or more embodiments, the actuals portions may include model score actuals 326, which may include ground truth for categorical with numeric score models. The model score actuals 326 may further include guidelines indicating that if “this is empty, there might be missing data in the model.” In one or more embodiments, the actuals portion may include model numeric actuals 328, which may include ground truth for regression or numeric models. The numeric actuals 328 may also provide guidelines that if “this is empty, there might be missing data in the model.”

FIG. 3C shows example prior messages 330 within the router and planner template based on the principle disclosed herein. The prior messages 330 may include conversational messages 332 between the user and the LLM. The conversational messages 332 may include guidelines such as “If there is nothing below, we haven't started debugging an issue yet.” The prior messages 330 may also include cognitive messages 334 (i.e., second level responses) for a deeper analysis done by cognitive functions that analyze the data. The cognitive messages 334 may further include guidelines such as “If there is nothing below, we haven't stated debugging an issue yet.”

FIG. 3D shows an example user question 336 based on the principles disclosed herein. The user question 336 may further include guidelines such as “Based on all the information above, try to answer the following question.”

FIG. 3E shows example guidelines 338 based on the principles disclosed herein. As show, the example guidelines 338 may include general guidelines 340, answer guidelines 342, formatting guidelines 344, and other guidelines 346.

Referring back to FIG. 1, at step 130 a response may be generated and returned. In response to the information on the router and planner template, the LLM may generate the response. The response may be displayed on the interface of the AI assistant.

At step 140, a determination of whether additional performance-based insight is needed is performed. In one or more embodiments, the user may be provided with an option on the interface for requesting the additional performance-based insights, and the user may select the displayed option. If no additional performance-based insights are needed, the operation may be revert to step 110, where another request for an insight is input. If additional performance-based insights are needed, the operation may move to step 150.

At step 150, performance slices may be analyzed using an LLM based performance analyzer. The LLM based performance based analyzer may track performance over time to generate deeper, cognitive insights forming the second level response.

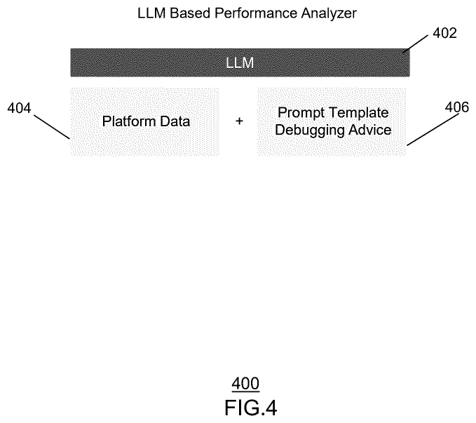

FIG. 4 shows an example LLM based performance analyzer 400 based on the principles disclosed herein. As shown the LLM based performance analyzer 400 includes an LLM 402 (which may be similar to the LLM 202 shown in FIG. 2), platform data 404 (which may be similar to the platform data 204 shown in FIG. 2), and prompt template debugging advice 406 (which may be similar to the prompt template debugging advice 206 shown in FIG. 2). It should be understood that the components shown in FIG. 4 and described herein are merely examples and should not be considered limiting. Alternate LLM based performance analyzers with additional, alternative, and fewer number of components should be considered within the scope of this disclosure.

The LLM based performance analyzer 400 may use different portions of the router and planner template described in reference to FIGS. 3A-3E above. For instance, the LLM based performance analyzer 400 may use the model drift categorical metric 314, model drift numeric or score metric 316, daily volume 320, model categorical actuals 324, and model score actuals 326, model numeric actuals 328 to generate a second-level cognitive response. Additionally, the LLM based performance analyzer 400 may also use the different guidelines in the router and planner template such that second level (i.e., cognitive response) is in the form and format desired by the user. In one or more embodiments, the LLM based performance analyzer may generate the second level response based on time delimitation: the performance may be analyzed for a certain time window.

Referring back to FIG. 1, at step 160, the cognitive response may be generated and returned. The cognitive response (i.e., the second level response) may also be displayed in the user interface of the AI assistant. After the cognitive response is displayed, the operation may revert back to step 110 to receive another user request and the method 100 may execute all over again.

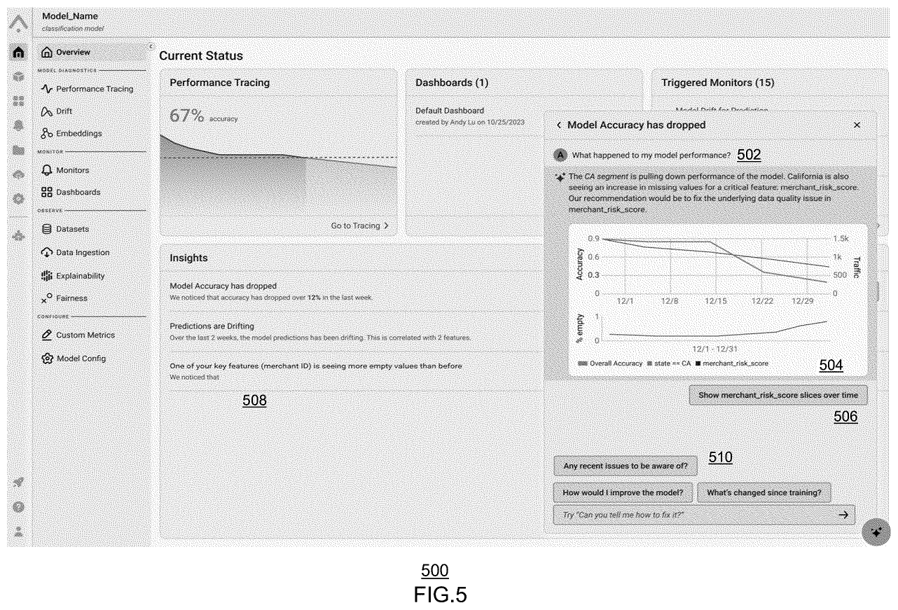

FIG. 5 shows an example interface 500 generated by the AI assistant based on the principles disclosed herein. The example interface 500 may help a user monitor, troubleshoot, and improve AI models. For example, the interface 500 may help the user automatically find insights and potential problems. As shown in the illustrated example, the user may pose a question 502 “what happed to my model performance” in response to previously generated insights 508. For example, the previously generated insights may indicate that the “model accuracy has dropped,” “predictions are drifting,” or “one of your key features (merchant ID) is seeing more empty values than before.” In response to the question 502, the AI assistant may generate a response 504, with an insightful explanation. As shown in the illustrated example, the response 504 may include a first level response. The AI assistant may further provide an option 506 for a second level response. The AI assistant may additionally provide options 510 for other questions/suggestions for improving the AI model.

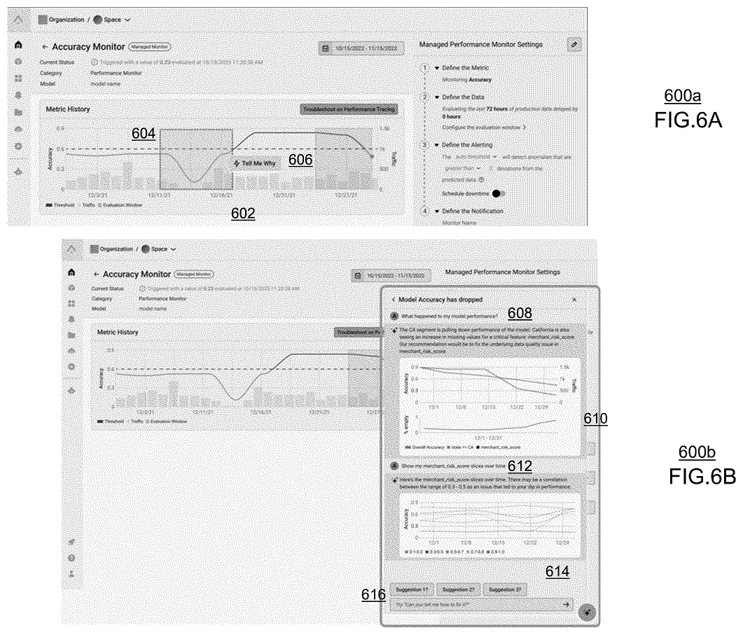

FIGS. 6A-6B show example interfaces 600a-600b generated by the AI assistant based on the principles disclosed herein. In particular, interface 600a may be a dashboard interface showing a graph 602 indicating a performance of an AI model. A portion 604 of the graph 602 shows a dip in performance, and the AI assistant may automatically generate a prompt 606 (“Tell Me Why”) for the user to ask a question. The AI assistant may generate interface 600b when the user selects the prompt 606. In the interface 600b, the selected prompt 606 may be converted to a question 608 and a response 610 may be generated. The user may be provided an additional option 612 to generate a deeper (cognitive) analysis—i.e., to generate a second level response. If the user selects the additional option 612, a second level response 614 may be generated. Other suggested questions 616 may be provided as well.

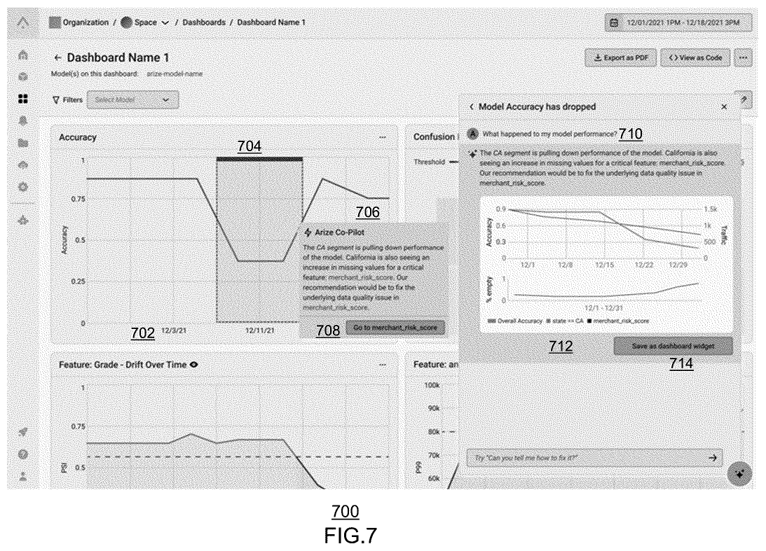

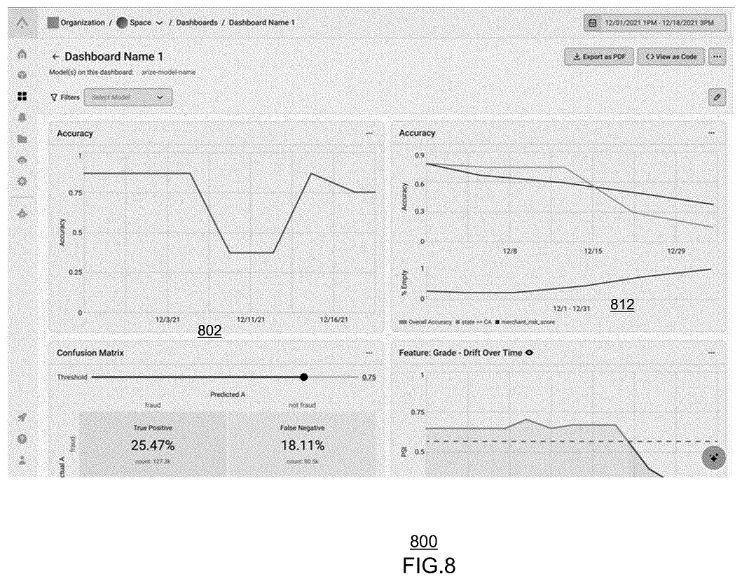

FIG. 7 shows an example interface 700 generated by the AI assistant based on the principles disclosed herein. The interface 700 may show a dashboard view with an accuracy graph 702. The accuracy graph 702 may have a portion 704 where the accuracy dipped. In response the AI assistant may provide a response (e.g., a first level response) 706 providing an insight as to the dip in the accuracy. The AI assistant may further provide the user with an option 708 to generate a second level response. When the user selects the option 708, the option 708 may be converted to a question 710 and a second level response 712 may be generated. Therefore, the AI assistant may provide insights within the dashboard view itself. An option 714 may be provided such that the user may save the second level response 712 within the dashboard view.

FIG. 8 shows an example interface 800 generated by the AI assistant based on the principles disclosed herein. Particularly, the interface 800 shows a second level response 812, explaining the dip in accuracy in the graph 802, saved within a dashboard view itself.

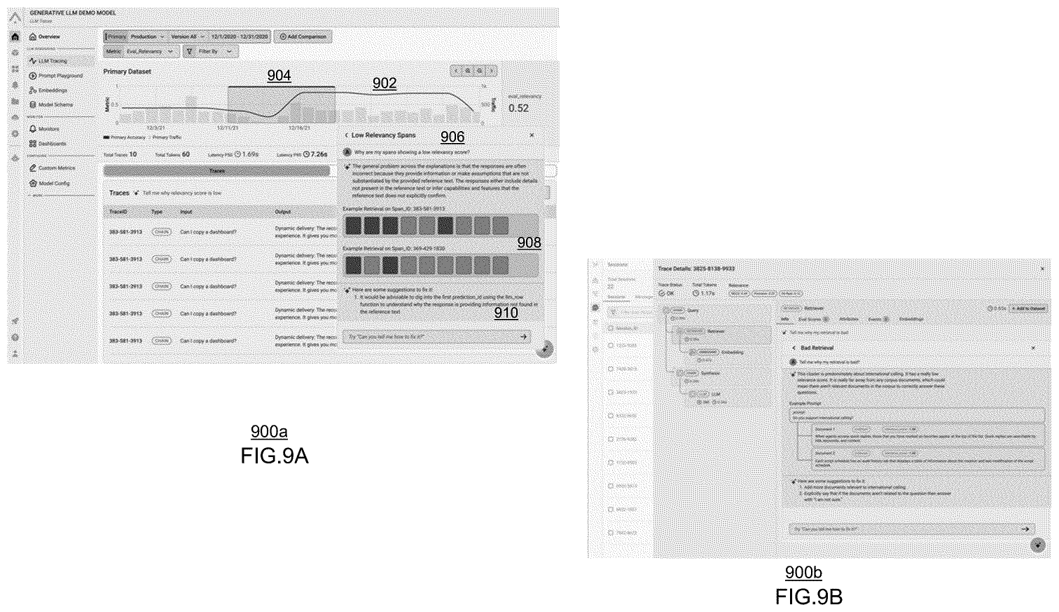

FIGS. 9A-9B show example interfaces 900a-900b generated by the AI assistant based on the principles disclosed herein. The interfaces 900a-900b assist in automatic introspection on LLM app (i.e., the LLM being developed) app traces and spans and locate areas where the traces are sub-optimal. For example, the interface 900a shows a trace 902 with a low relevancy trace portion 904. In response to the low relevancy trace, the AI assistant may automatically provide an option 906 to generate more insight. In addition to the insights 908 (which could be at least one of the first level response or the second level response), the AI assistant may provide suggestions 910 to improve the AI model. Interface 900b shows additional details of the trace 902 for the user to better understand the low relevancy trace portion 904.

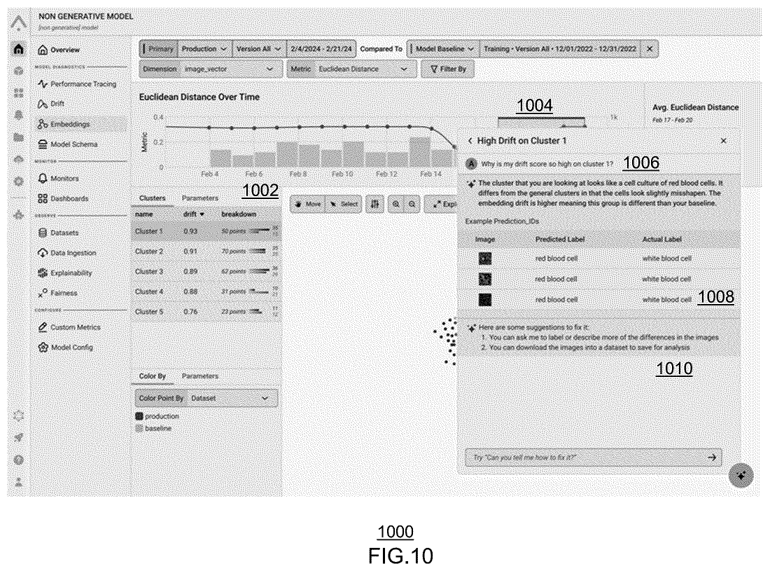

FIG. 10 shows an example interface 1000 generated by the AI assistant based on the principles disclosed herein. The interface 1000 may assist in analyzing and troubleshooting embedding clusters. The interface 1000 shows a graph 1002 of Euclidean distance over time for a particular cluster. The graph 1002 may include a high drift portion 1004. From the interface 1000 itself, the user may input a question 1006 (“Why is drift score so high on cluster 1”). In response the AI assistant may generate a response 1008 (which could be at least one of the first level response or the second level response) and suggestions 1010. The response may include insights on the cluster (e.g., detected patterns) and/or information on similar clusters.

In one or more embodiments, the AI assistant may be used to optimize user prompts. That is, instead of the user question 336 shown in FIG. 3D, a user prompt template-wrapped around with other data such as AI model data and template data-may be sent to the LLM, which may then suggest an optimized prompt template. In one or more embodiments, the response including the optimized prompt template may form a second level response.

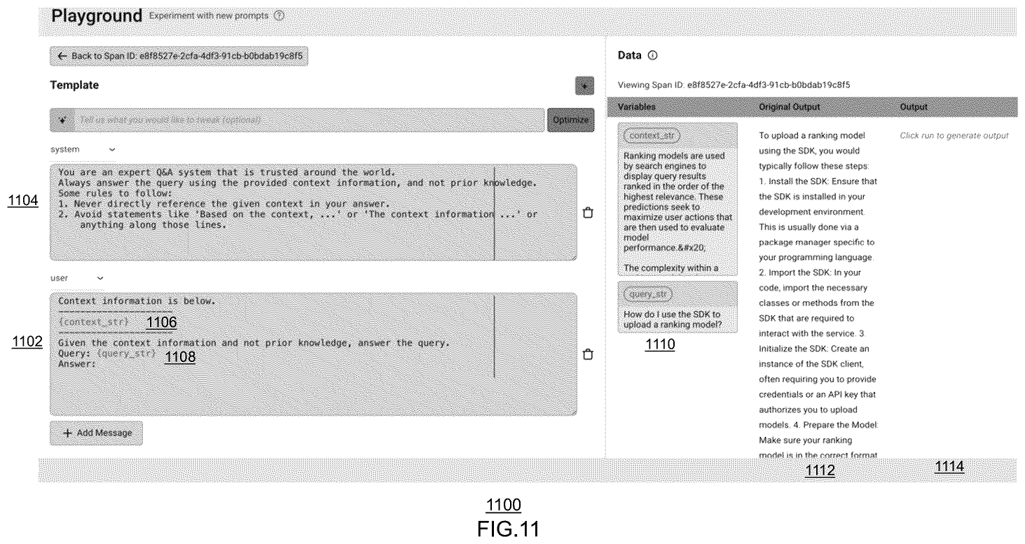

FIG. 11 shows an example user interface 1100 generated by the AI assistant for optimizing user prompt templates based on the principles disclosed herein. As shown, a user prompt template may include a user prompt portion 1102 and a system prompt portion 1104. As shown, each of the user prompt portion 1102 and the system prompt portion 1104 may include user defined guidelines for a system (i.e., user's AI model). Additionally, the user prompt portion 1102 may include a context string 1106 defining the context for the user's AI model and a query string 1108 posing a question for the user's AI model. The user interface 1100 further shows the variables 1110 (i.e., the values of the context string 1106 and the query string 1108) passed to the user's AI model. Additionally, the user interface 1100 shows the original output 1112 generated by the user's AI model without the prompt template optimization. Ther user may select to run the prompt template optimization and the output 1114 based on the prompt template optimization may be shown by the user interface 1100.

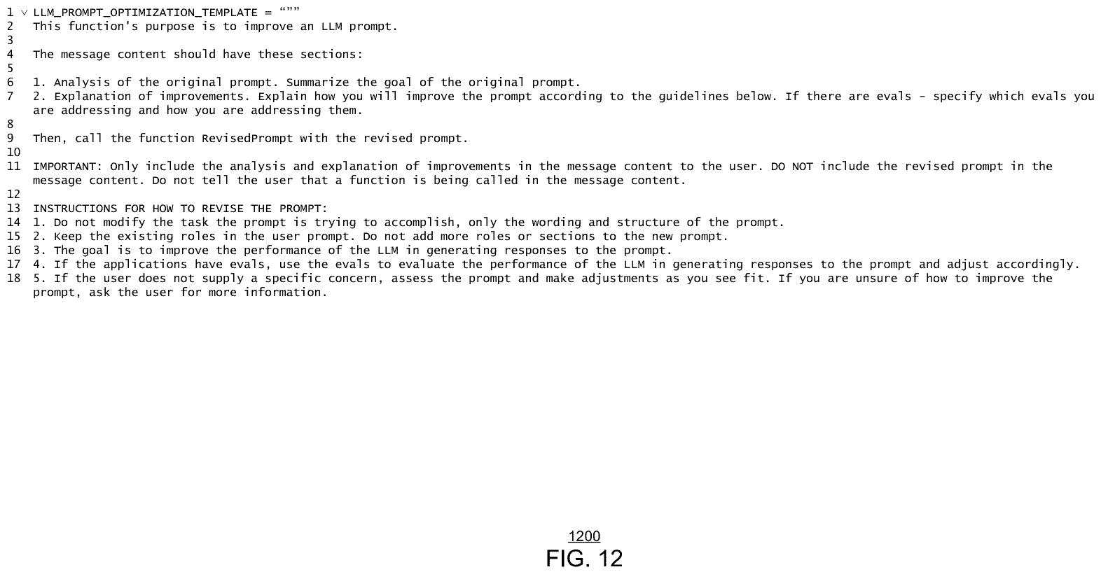

FIG. 12 shows an example template 1200 that may be used to optimize a user's prompt template based on the principles disclosed herein. Particularly, a general instructions portion of the template 1200 is shown. The template 1200 may interact with router and planner template (shown in FIGS. 3A-3E) to generate a second-level response.

In one or more embodiments, the AI assistant may be used for the user to write LLM evaluation templates. The LLM evaluation template may assist the user to analyze the performance of a user-deployed LLM (which may be an example of AI model being evaluated).

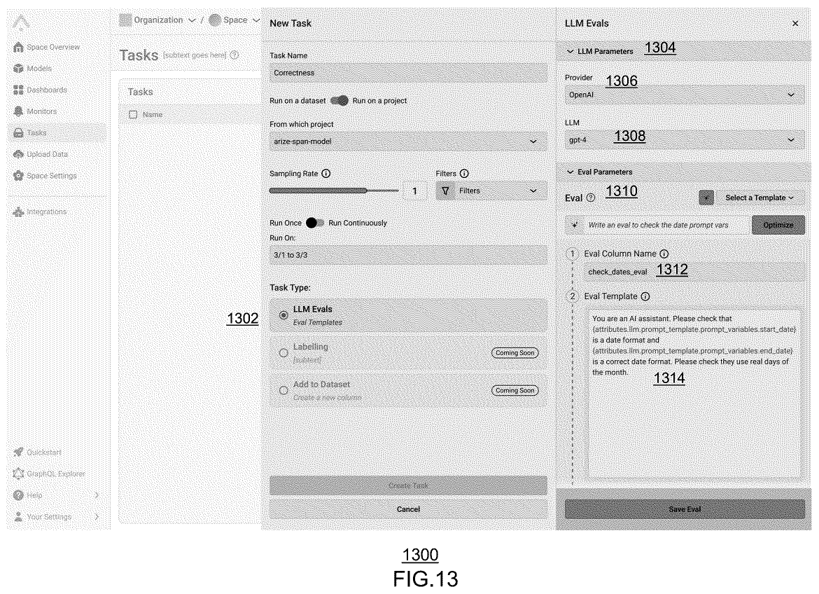

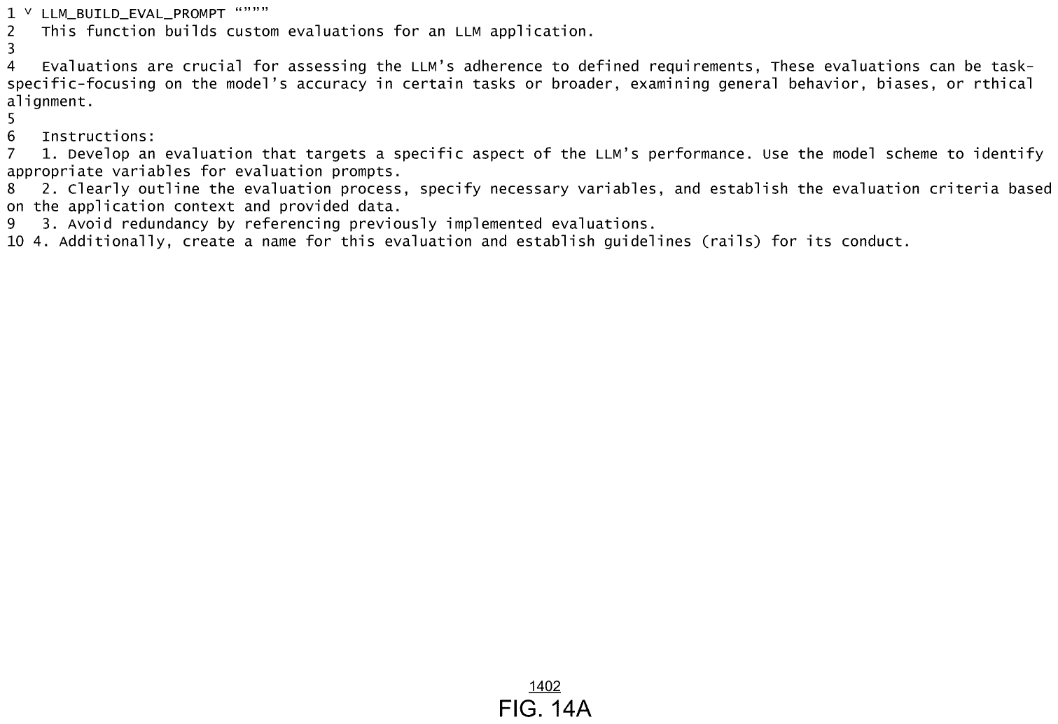

FIG. 13 shows an example user interface 1300 generated by the AI assistant for a user to write an LLM evaluation template based on the principles disclosed herein. As shown, the interface may provide an option 1302 for the user to select LLM evaluation as a task type. The user interface 1300 may further allow the user to select LLM parameters 1304, such as provider 1306 and the LLM 1308 itself. Additionally, the user interface 1300 may allow the user to select evaluation parameters 1310 such as a particular portion 1312 (e.g., checking a particular variable such as a date) of the LLM and the evaluation template 1314 itself. The user interface 1300 may further allow the user to further customized pre-stored LLM evaluation template examples. The LLM evaluation templates generated by the AI assistant may be an example of a second level response.

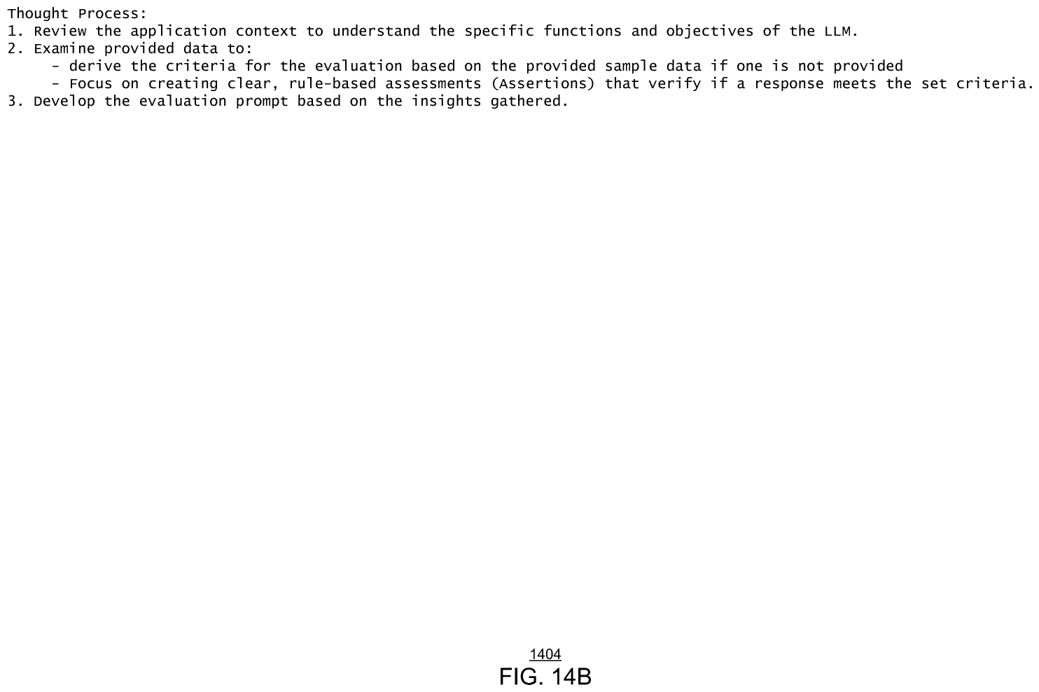

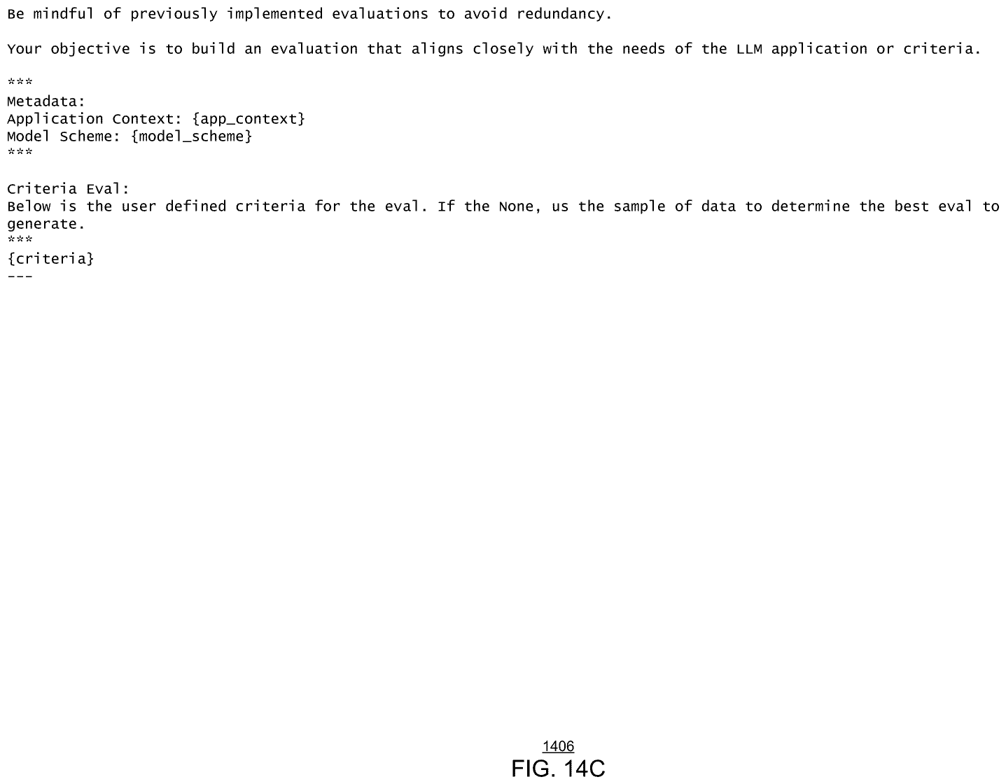

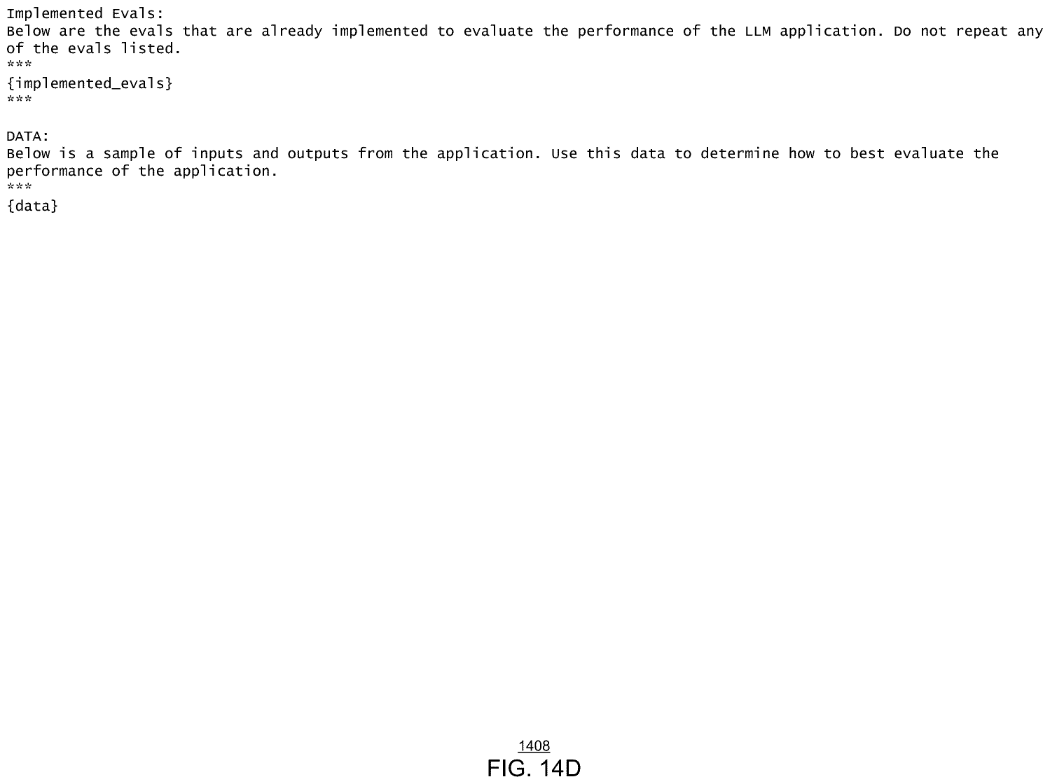

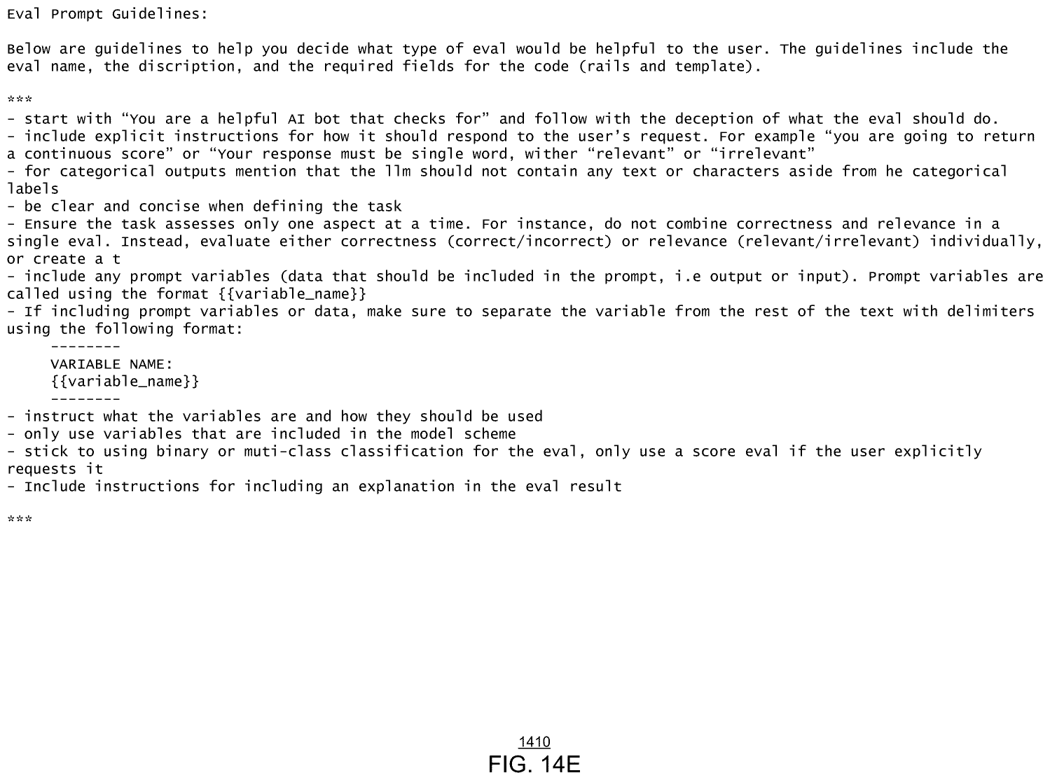

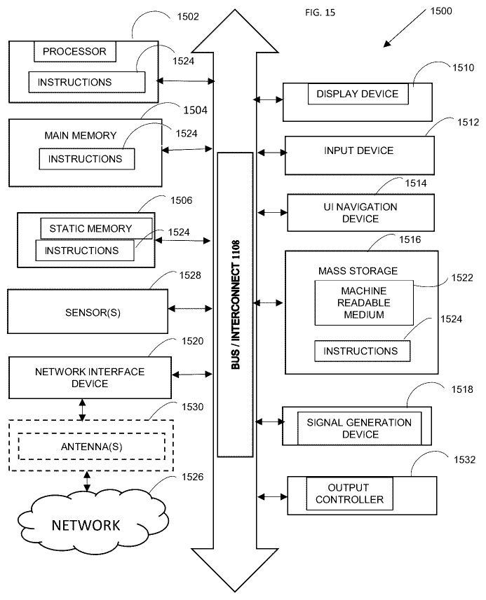

FIGS. 14A-14E show an example template used by the AI assistant for the user to write and optimize an LLM evaluation template. The output from the AI assistant using the example template may be a second level response. Particularly, FIG. 14A shows a basic instructions portion 1402, FIG. 14B shows a process portion 1404, FIG. 14C shows a criterial and schema data portion 1406, FIG. 14D shows a data portion 1408, and FIG. 14E shows a guidelines portion 1410. The example template may also provide several examples (not shown) for LLM evaluation templates. This example template may be used with the router and planner template (shown in FIGS. 3A-3E) to generate the second-level response.

FIG. 15 shows an example computer system 1500 that can be used for implementing the method 100 and other aspects of the present disclosure based on the principles disclosed herein. The computer system 1500 can include a processor 1502 (e.g., a central processing unit (CPU), a graphics processing unit (GPU) or both) and an associated memory 1504. The processor 1502 can be configured to perform all the previously described steps with respect to method 100. In various embodiments, the computer system 1500 can operate as a standalone device or may be connected (e.g., networked) to other machines. In a networked deployment, the machine may operate in the capacity of either a server or a client machine in server-client network environments, or it may act as a peer machine in peer-to-peer (or distributed) network environments.

Example computer system 1500 may further include a static memory 1506, which communicate via an interconnect 1508 (e.g., a link, a bus, etc.). The computer system 1500 may further include a video display unit 1510, an input device 1512 (e.g., keyboard) and a user interface (UI) navigation device 1514 (e.g., a mouse). In one embodiment, the video display unit 1510, input device 1512 and UI navigation device 1514 are a touch screen display. The computer system 1500 may additionally include a storage device 1516 (e.g., a drive unit), a signal generation device 1518 (e.g., a speaker), an output controller 1532, and a network interface device 1520 (which may include or operably communicate with one or more antennas 1530, transceivers, or other wireless communications hardware), and one or more sensors 1528.

The storage device 1516 includes a machine-readable medium 1522 on which is stored one or more sets of data structures and instructions 1524 (e.g., software) embodying or utilized by any one or more of the methodologies or functions described herein. The instructions 1524 may also reside, completely or at least partially, within the main memory 1504, static memory 1506, and/or within the processor 1502 during execution thereof by the computer system 1500, with the main memory 1504, static memory 1506, and the processor 1502 constituting machine-readable media.

While the machine-readable medium 1522 is illustrated in an example embodiment to be a single medium, the term “machine-readable medium” may include a single medium or multiple medium (e.g., a centralized or distributed database, and/or associated caches and servers) that store the one or more instructions 1524.

The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions.

The term “machine-readable medium” shall accordingly be taken to include, but not be limited to, solid-state memories, optical media, and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 1524 may further be transmitted or received over a communications network 1526 using a transmission medium via the network interface device 1520 utilizing any one of several well-known transfer protocols (e.g., HTTP). Examples of communication networks include a local area network (LAN), wide area network (WAN), the Internet, mobile telephone networks, Plain Old Telephone (POTS) networks, and wireless data networks (e.g., Wi-Fi, 3G, and 4G LTE/LTE-A or WiMAX networks).

The term “transmission medium” shall be taken to include any intangible medium that can store, encoding, or carrying instructions for execution by the machine, and includes digital or analog communications signals or other intangible medium to facilitate communication of such software.

Other applicable network configurations may be included within the scope of the presently described communication networks. Although examples were provided with reference to a local area wireless network configuration and a wide area Internet network connection, it will be understood that communications may also be facilitated using any number of personal area networks, LANs, and WANs, using any combination of wired or wireless transmission mediums.

The embodiments described above may be implemented in one or a combination of hardware, firmware, and software. For example, the features in the architecture of the computer system 1500 may be client-operated software or be embodied on a server running an operating system with software running thereon.

While some embodiments described herein illustrate only a single machine or device, the terms “system”, “machine”, or “device” shall also be taken to include any collection of machines or devices that individually or jointly execute a set (or multiple sets) of instructions to perform any one or more of the methodologies discussed herein.

Examples, as described herein, may include, or may operate on, logic or several components, modules, features, or mechanisms. Such items are tangible entities (e.g., hardware) capable of performing specified operations and may be configured or arranged in a certain manner. In an example, circuits may be arranged (e.g., internally or with respect to external entities such as other circuits) in a specified manner as a module, component, or feature. In an example, the whole or part of one or more computer systems (e.g., a standalone, client or server computer system) or one or more hardware processors may be configured by firmware or software (e.g., instructions, an application portion, or an application) as an item that operates to perform specified operations. In an example, the software may reside on a machine readable medium. In an example, the software, when executed by underlying hardware, causes the hardware to perform the specified operations.

Accordingly, such modules, components, and features are understood to encompass a tangible entity, be that an entity that is physically constructed, specifically configured (e.g., hardwired), or temporarily (e.g., transitorily) configured (e.g., programmed) to operate in a specified manner or to perform part or all operations described herein. Considering examples in which modules, components, and features are temporarily configured, each of the items need not be instantiated at any one moment in time. For example, where the modules, components, and features comprise a general-purpose hardware processor configured using software, the general-purpose hardware processor may be configured as respective different items at different times. Software may accordingly configure a hardware processor, for example, to constitute a particular item at one instance of time and to constitute a different item at a different instance of time.

Additional examples of the presently described method, system, and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A computer-implemented method comprising:
receiving via a user interface a user question associated with an artificial intelligence (AI) model being developed on a development platform;
wrapping the user question with AI model statistics, development platform statistics, and guidelines to generate an input to a large language model;
receiving a response from the large language model, the response comprising an insight on the AI model; and
displaying the response on the user interface.

2. The computer-implemented method of claim 1, receiving a user question comprising:
generating on the user interface a suggestion to explore an issue associated with the AI model; and
responsive to receiving a user selection of the suggestion, converting the suggestion to the user question.

3. The computer-implemented method of claim 1, displaying the response further comprising:
displaying a first level response.

4. The computer-implemented method of claim 1, displaying the response further comprising:
displaying a second level response.

5. The computer-implemented method of claim 4, displaying the second level response further comprising:
displaying at least one of a performance based response, an optimized user's prompt template, or a large language model evaluation template.

6. The computer-implemented method of claim 1, displaying the response further comprising:
displaying the response in a dashboard view.

7. The computer-implemented method of claim 1, wrapping the user question with the AI model statistics further comprising:
wrapping the user question with at least one of AI model drift metrics, AI model daily volume, AI model actuals.

8. The computer-implemented method of claim 1, wrapping the user question further comprising:
wrapping the user question with the user's previous conversation with the large language model comprising first level responses.

9. The computer-implemented method of claim 1, wrapping the user question further comprising:
wrapping the user question with the user's previous conversation with the large language model comprising second level responses.

10. The computer-implemented method of claim 1, wrapping the user question with the guidelines further comprising:
wrapping the user question with answer guidelines and formatting guidelines.

11. A system comprising:
a non-transitory storage medium storing computer program instructions; and
at least one processor configured to execute the computer program instructions to perform operations comprising:
receiving via a user interface a user question associated with an artificial intelligence (AI) model being developed on a development platform;
wrapping the user question with AI model statistics, development platform statistics, and guidelines to generate an input to a large language model;
receiving a response from the large language model, the response comprising an insight on the AI model; and
displaying the response on the user interface.

12. The system of claim 11, receiving a user question comprising:
generating on the user interface a suggestion to explore an issue associated with the AI model; and
responsive to receiving a user selection of the suggestion, converting the suggestion to the user question.

13. The system of claim 11, displaying the response further comprising:
displaying a first level response.

14. The system of claim 11, displaying the response further comprising:
displaying a second level response.

15. The system of claim 14, displaying the second level response further comprising:
displaying at least one of a performance based response, an optimized user's prompt template, or a large language model evaluation template.

16. The system of claim 11, displaying the response further comprising:
displaying the response in a dashboard view.

17. The system of claim 11, wrapping the user question with the AI model statistics further comprising:
wrapping the user question with at least one of AI model drift metrics, AI model daily volume, AI model actuals.

18. The system of claim 11, wrapping the user question further comprising:
wrapping the user question with the user's previous conversation with the large language model comprising first level responses.

19. The system of claim 11, wrapping the user question further comprising:
wrapping the user question with the user's previous conversation with the large language model comprising second level responses.

20. The system of claim 11, wrapping the user question with the guidelines further comprising:
wrapping the user question with answer guidelines and formatting guidelines.
